(19) United States
(12) Patent Application Publication
(10) Pub. No.: US 2010/0005610 A1
(43) Pub. Date: Jan. 14, 2010

(54) MODIFIED OPEN-CELL FOAM MATERIALS AND USE THEREOF IN VACUUM CLEANERS

(75) Inventors: Ulf Baus, Dossenheim (DE); Stefan Frenzel, Mannheim (DE); Bernhard Vath, Mannheim (DE); Christof Moeck, Mannheim (DE); Stefan Tiekoetter, Bielefeld (DE); Andre Bertram, Bielefeld (DE); Joerg Kinnius, Spenge (DE); Cornelius Wolf, Bielefeld (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/374,204

(22) PCT Filed: Jul. 11, 2007
(86) PCT No.: PCT/EP07/57085

§ 371 Date: Jan. 16, 2009

(30) Foreign Application Priority Data
Jul. 21, 2006 (DE) 102006034312.3

(51) Int. Cl. A47L 9/00; C08J 9/00

(52) U.S. Cl. 15/300.1; 428/220

(57) ABSTRACT

Use of moldings whose length width height dimensions are always in the range from 1 mm to 3 cm, at least one dimension being greater than 5.5 mm, produced by treatment of
(a) open-cell foam whose density is in the range from 5 to 500 kg/m³ and whose average pore diameter is in the range from 1 μm to 1 mm
(b) with an aqueous formulation of at least one compound having at least one hemiaminal or aminal group per molecule or at least one copolymer containing at least one copolymerized comonomer which contains OH groups or which contains β-dicarbonyl groups, or which contains epoxy groups,
(c) and a shaping step,
   as dust binders in vacuum cleaners.

The present invention relates to the use of moldings whose length·width·height dimensions are always in the range from 1 mm to 3 cm, at least one dimension being greater than 5.5 mm, produced by treatment of
(a) open-cell foam whose density is in the range from 5 to 500 kg/m³ and whose average pore diameter is in the range from 1 μm to 1 mm
(b) with an aqueous formulation of at least one compound having at least one hemiaminal or aminal group per molecule or at least one copolymer containing at least one copolymerized comonomer which contains OH groups or which contains β-dicarbonyl groups, or which contains epoxy groups,
(c) and a shaping step,
   as dust binders in vacuum cleaners.

The present invention further relates to the use of sheet-like moldings whose thickness is in the range from 0.5 to 1.5 cm, produced by treatment of
(a) open-cell foam whose density is in the range from 5 to 500 kg/m³ and whose average pore diameter is in the range from 1 μm to 1 mm
(b) with an aqueous formulation of at least one compound having at least one hemiaminal or aminal group per molecule or at least one copolymer containing at least one copolymerized comonomer which contains OH groups or which contains β-dicarbonyl groups, or which contains epoxy groups,
(c) and a shaping step,
   as dust binders in vacuum cleaners.

The present invention further relates to moldings and to a process for their production. The present invention further relates to vacuum cleaners, comprising moldings of the invention.

Foams, and specifically those known as open-cell foams, are used in numerous applications. In particular, open-cell foams composed of synthetic materials have proven to be versatile. Examples that may be mentioned are seat cushions, filter materials, air-conditioning systems, and automobile parts, and also cleaning materials.

Vacuum cleaners, especially those used for floors, often use dust-retention systems arranged between the air inlet of a dust collection space and the suction side of a fan, which retain the dust prior to entry into the fan. One particularly known variant is a filter shaped as a bag, the inner side of which is exposed to the dust, i.e. the dust forms a deposit in the interior of the filter shaped as a bag. Such filters require regular replacement. Some vacuum cleaners, in particular microvacuum cleaners, multipurpose vacuum cleaners, or industrial equipment, have filters which surround the fan and whose outer side is exposed to the dust. An advantage of these is greater absorption capacity; a disadvantage is that such filters are designed only for coarse dust, while fine dust, which can include allergenic pollen and microorganisms, passes through this filter and is blown back by the fan into the space requiring vacuum cleaning, the actual result being raising of the dust.

WO 06/58675 describes the production of modified foams and proposes their use by way of example as filter material.

Alongside the vacuum cleaners described above, having a bag, there are those known as “bagless vacuum cleaners” which operate with no dust bag. They generally comprise a cyclone for dust separation or preliminary dust deposition, and a downstream fine dust filter. A disadvantage of bagless systems known hitherto is that emptying of the cyclone—mostly by way of a valve on the base of the dust collection container—produces a dust cloud, which is an unhygienic aspect of said system.

It was an object to provide a dust binder which is particularly suitable for use in vacuum cleaners and which by way of example has high dust-accummulation capacity, where its arrangement is hygienically entirely satisfactory, and which is capable of binding fine dust. A further object was to provide a process for the production of dust binders of the invention.

Accordingly, the use defined in the introduction has been found for moldings.

According to the invention, moldings are used whose length·width·height dimensions are always in the range from 1 mm to 3 cm, at least one dimension being greater than 5.5 mm, produced by treatment of
(a) open-cell foam whose density is in the range from 5 to 500 kg/m³ and whose average pore diameter is in the range from 1 μm to 1 mm
(b) with an aqueous formulation of at least one compound having at least one hemiaminal or aminal group per molecule or at least one copolymer containing at least one copolymerized comonomer which contains OH groups or which contains β-dicarbonyl groups, or which contains epoxy groups,
(c) and a shaping step,
   as dust binders in vacuum cleaners.

According to the invention, sheet-like moldings whose thickness is in the range from 0.5 to 1.5 cm, produced by treatment of
(a) open-cell foam whose density is in the range from 5 to 500 kg/m³ and whose average pore diameter is in the range from 1 μm to 1 mm
(b) with an aqueous formulation of at least one compound having at least one hemiaminal or aminal group per molecule or at least one copolymer containing at least one copolymerized comonomer which contains OH groups or which contains β-dicarbonyl groups, or which contains epoxy groups,
(c) and a shaping step,
   can be used as dust binders in vacuum cleaners.

For the purposes of the present invention, aqueous formulation here can mean solutions, emulsions, or dispersions.

The length·width·height dimensions of moldings used according to the invention are always in the range from 1 mm to 3 cm, at least one dimension, i.e. length or width or height, being greater than 5.5 mm. It is also possible that at least two, or all three, dimensions are greater than 5.5 mm.

In one embodiment of the present invention, moldings of the invention take the form of cylinders, square columns, saddles, spheres, flakes, granules, blocks, or cubes, preferably being shaped as tablets or sliced material (pellets), or else take the form of stars, letters of the alphabet, or hedgehog-shaped moldings, or moldings comprising cavities.

In another embodiment of the present invention, moldings of the invention are sheet-like, with thickness in the range from 0.5 to 1.5 cm. Length and width here are preferably markedly greater than thickness, for example five times as great, preferably at least ten times as great. Length and width can be equal or different.

In the last-mentioned embodiment, sheet-like moldings of the invention resemble, for example, a mat, a nonwoven, or a piece of fabric.

In one embodiment of the present invention, moldings used according to the invention are of approximately the same size, and this means that the dimensions can vary by up to ±10%.

Production of moldings used according to the invention starts from open-cell foam.

In one embodiment of the present invention, open-cell foams used according to the invention are those based on synthetic organic foam, for example based on unmodified organic foams, examples being foams based on polyurethane foams or on aminoplastic foams, for example composed of urea-formaldehyde resins, and also foams based on phenol-formaldehyde resins and in particular foams based on polyurethanes or on aminoplastic-formaldehyde resins, in particular on melamine-formaldehyde resins, and for the purposes of the present invention foams based on polyurethanes are also termed polyurethane foams, and foams based on melamine-formaldehyde resins are also termed melamine foams.

This means that moldings used according to the invention are produced from open-cell foams which comprise synthetic organic materials, preferably polyurethane foams or aminoplastic foams, and in particular melamine foams.

The unmodified open-cell foams (a) used for the production of moldings of the invention are very generally also termed unmodified foams (a) for the purposes of the present invention. The unmodified open-cell foams (a) used for conduct of the process of the invention are described in more detail below.

Open-cell foams (a) are used as starting material for conduct of the production process of the invention, in particular foams in which at least 50% of all of the cell walls are open, preferably from 60 to 100%, and particularly preferably from 65 to 99.9%, determined to DIN ISO 4590.

Foams (a) used as starting material are preferably rigid foams, and for the purposes of the present invention these are foams whose compressive hardness, determined to DIN 53577, is 1 kPa or more for 40% compression.

The density of foams (a) used as starting material is in the range from 3 to 500 kg/m³, preferably from 6 to 300 kg/m³, and particularly preferably in the range from 7 to 300 kg/m³.

The average pore diameter (number average) of open-cell foams (a) used as starting material can be in the range from 1 μm to 1 mm, preferably from 50 to 500 μm, determined by evaluating micrographs of sections.

In one embodiment of the present invention, open-cell foams (a) used as starting material can have a maximum of 20, preferably a maximum of 15, and particularly preferably a maximum of 10, pores per m² whose diameter is in the range up to 20 mm. The diameter of the other pores is usually smaller.

In one embodiment of the present invention, the BET surface area of open-cell foams (a) used as starting material is in the range from 0.1 to 50 m²/g, preferably from 0.5 to 20 m²/g, determined to DIN 66131.

In one embodiment of the present invention, the starting material used comprises open-cell foams (a) composed of synthetic organic material, and preferably comprises polyurethane foams or melamine foams.

Polyurethane foams particularly suitable as starting material for the conduct of the process of the invention are known per se. Their production is achieved by way of example by a reaction of
i) one or more polyisocyanates, i.e. compounds having two or more isocyanate groups,
ii) with one or more compounds having at least two groups reactive toward isocyanate, in the presence of
iii) one or more blowing agents,
iv) one or more initiators,
v) and one or more catalysts, and also
vi) materials known as cell openers.

Initiators iv) and blowing agents iii) here can be identical.

Examples of suitable polyisocyanates i) are aliphatic, cycloaliphatic, araliphatic, and preferably aromatic polyfunctional compounds known per se, having two or more isocyanate groups.

Individual examples that may be mentioned are:

C₄-C₁₂-Alkylene diisocyanates, preferably hexamethylene 1,6-diisocyanate; cycloaliphatic diisocyanates, e.g. cyclohexane 1,3-diisocyanate and cyclohexane 1,4-diisocyanate, and also any desired mixtures of said isomers, 1-isocyanato-3,3,5-trimethyl-5-isocyanatomethylcyclohexane (isophorone d iisocyanate, IPDI), preferably aromatic di- and polyisocyanates, e.g. tolylene 2,4- and 2,6-diisocyanate, and corresponding isomer mixtures, diphenylmethane 4,4′-, 2,4′-, and 2,2′-diisocyanate and corresponding isomer mixtures, and mixtures composed of diphenylmethane 4,4′- and 2,4′-diisocyanates, further examples being polyphenyl polymethylene polyisocyanates, mixtures composed of diphenylmethane 4,4′-, 2,4′-, and 2,2′-diisocyanates and of polyphenyl polymethylene polyisocyanates (crude MDI), and mixtures of crude MDI with tolylene diisocyanates. Polyisocyanates can be used individually or in the form of mixtures.

Particular examples that may be mentioned of ii) compounds having at least two groups reactive toward isocyanate are diols and polyols, in particular polyether polyols (polyalkylene glycols), which are prepared by methods known per se, for example being obtainable by alkali-metal-hydroxide-catalyzed polymerization of one or more alkylene oxides, such as ethylene oxide, propylene oxide, and butylene oxide.

Very particularly preferred compounds II) are ethylene glycol, propylene glycol, butylene glycol, 1,3-propanediol, 1,4-butanediol, 1,6-hexanediol, diethylene glycol, dipropylene glycol, triethylene glycol, tripropylene glycol, tetraethylene glycol, pentaethylene glycol, hexaethylene glycol.

Suitable blowing agents iii) are: water, inert gases, in particular carbon dioxide, and those known as physical blowing agents. Physical blowing agents are compounds which are inert with respect to the starting components and which are mostly liquid at room temperature, and which evaporate under the conditions of the urethane reaction. The boiling point of said compounds is preferably below 110° C., in particular below 80° C. Among the physical blowing agents are also inert gases which are introduced into the starting components i) and ii) or are dissolved in these, examples being carbon dioxide, nitrogen, and noble gases.

Suitable compounds which are liquid at room temperature are mostly selected from the group comprising alkanes and/or cycloalkanes having at least 4 carbon atoms, dialkyl ethers, esters, ketones, acetals, fluoroalkanes having from 1 to 8 carbon atoms, and tetraalkylsilanes having from 1 to 3 carbon atoms in the alkyl chain, in particular tetramethylsilane.

Examples that may be mentioned are: propane, n-butane, iso- and cyclobutane, n-, iso-, and cyclopentane, cyclohexane, dimethyl ether, methyl ethyl ether, methyl tert-butyl ether, methyl formate, acetone, and also fluorinated alkanes which can be degraded in the troposphere and are therefore not detrimental to the ozone layer, examples being trifluoromethane, difluoromethane, 1,1,1,3,3-pentafluorobutane, 1,1,1,3,3-pentafluoropropane, 1,1,1,2-tetrafluoroethane, 1,1,1-trifluoro-2,2,2-trichloroethane, 1,1,2-trifluoro-1,2,2-trichloroethane, difluoroethanes, and heptafluoro-propane. The physical blowing agents mentioned can be used alone or in any desired combination with one another.

EP-A 0 351 614 discloses the use of perfluoroalkanes for generating open cells.

Examples of suitable initiators iv) are: water, organic dicarboxylic acids, aliphatic and aromatic, optionally N-mono-, N,N- and N,N′-dialkyl-disubstituted diamines having from 1 to 4 carbon atoms in the alkyl radical, e.g. optionally N-mono- and N,N-dialkyl-substituted ethylenediamine, diethylenetriamine, triethylenetetramine, 1,3-propylene-diamine, 1,3- or 1,4-butylenediamine, 1,2-, 1,3-, 1,4-, 1,5-, and 1,6-hexamethylene-diamine, aniline, phenylenediamines, 2,3-, 2,4-, 3,4-, and 2,6-tolylenediamine, and 4,4′-, 2,4′-, and 2,2′-diaminodiphenylmethane.

Suitable catalysts v) are the catalysts known in polyurethane chemistry, examples being tertiary amines, e.g. triethylamine, dimethylcyclohexylamine, N-methyl-morpholine, N,N′-dimethylpiperazine, 2-(dimethylaminoethoxy)ethanol, diazabicyclo-[2.2.2]-octane, and the like, and also in particular organic metal compounds, such as titanic esters, iron compounds, e.g. ferric acetylacetonate, tin compounds, e.g. stannous diacetate, stannous dioctoate, stannous dilaurate, or the dialkyl derivatives of dialkyltin salts of aliphatic carboxylic acids, e.g. dibutyltin diacetate and dibutyltin dilaurate.

Examples that may be mentioned of cell openers vi) are polar polyether polyols (polyalkylene glycols), i.e. those having high content of ethylene oxide in the chain, preferably at least 50% by weight. These have cell-opening action during the foaming process by virtue of demixing and of an effect on surface tension.

The quantitative proportions used of i) to vi) are those conventional in polyurethane chemistry.

Melamine foams particularly suitable as starting material for the conduct of the production process of the invention are known per se. Their production is achieved by way of example by foaming of
vii) a melamine-formaldehyde precondensate which can comprise, condensed into the molecule, not only formaldehyde but also further carbonyl compounds, such as aldehydes,
viii) one or more blowing agents,
ix) one or more emulsifiers,
x) one or more curing agents.

Melamine-formaldehyde precondensates vii) can be unmodified materials, but they can also be modified materials, and by way of example up to 20 mol % of the melamine can have been replaced by other thermoset-formers known per se, an example being alkyl-substituted melamine, and other examples being urea, urethane, carboxamides, dicyandiamide, guanidine, sulfurylamide, sulfonamides, aliphatic amines, phenol, and phenol derivatives. Modified melamine-formaldehyde precondensates can comprise by way of example, as further carbonyl compounds alongside formaldehyde, acetaldehyde, trimethylolacetaldehyde, acrolein, furfural, glyoxal, phthalaldehyde and terephthalaldehyde.

Blowing agents viii) used can be compounds the same as those described under iii).

Emulsifiers ix) used can be conventional nonionic, anionic, cationic, or betainic surfactants, in particular C₁₂-C₃₀-alkyl sulfonates, preferably C₁₂-C₁₈-alkyl sulfonates, and polyethoxylated C₁₀-C₂₀-alkyl alcohols, in particular of the formula R⁶—O(CH₂—CH₂—O)_{y}—H, where R⁶ is selected from C₁₀-C₂₀-alkyl, and y can by way of example be a whole number in the range from 5 to 100.

Particular curing agents x) that can be used are acidic compounds, such as inorganic Brønsted acids, e.g. sulfuric acid or phosphoric acid, organic Brønsted acids, such as acetic acid or formic acid, Lewis acids, and also compounds known as latent acids.

EP-A 0 017 672 reveals examples of suitable melamine foams.

Foams (a) used as starting material can naturally comprise additives conventional in foam chemistry, for example antioxidants, flame retardants, fillers, colorants, such as pigments or dyes, and biocides, for example

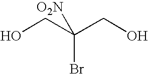

The production of the moldings of the invention moreover starts from at least one compound having at least one hemiaminal or aminal group per molecule, or from at least one copolymer containing at least one copolymerized comonomer which contains OH groups or which contains β-dicarbonyl groups, or which contains epoxy groups.

Compounds used having at least one hemiaminal or aminal group per molecule, and copolymers containing at least one copolymerized comonomer which contains OH groups or which contains β-dicarbonyl groups, or which contains epoxy groups, are also referred to hereinafter by the abbreviated term compound (b) or simply (b). Suitable examples of compound (b) are obtainable by way of example by condensation of at least one nitrogen-containing compound (B1) and of at least one carbonyl compound (B2) and, if appropriate, of further compounds (B3) and, if appropriate, further reactions after condensation.

In one embodiment of the present invention, at least one compound in step (b) preferably involves a compound which was not used in the production of unmodified foam (a).

Examples of nitrogen-containing compounds (B1) are urea, N,N′-dimethylurea, (meth)acrylic acid, triazones, tetrahydropyrimidinones, imidazolinones, tetrahydro-4H-1,3,5-oxadiazin-4-ones, alkyl carbamates, methoxyethyl carbamates, and methylol(meth)acrylamide.

Examples of carbonyl compounds (B2) are ketones, in particular di(C₁-C₁₀-alkyl)ketones, and preferably mono-, di-, and polyaldehydes, in particular C₁-C₁₀-alkyl monoaldehydes, such as acetaldehyde or propionaldehyde, and very particularly preferably formaldehyde, and also dialdehydes, such as glyoxal or phthalaldehyde, examples being 1,2-phthalaldehyde, butanedial, glutaraldehyde, and hexane-1,6-dial.

Examples of particularly preferred further compounds (B3) are mono- or polyhydric alcohols, for example C₁-C₁₀ alkanols, in particular methanol, ethanol, n-propanol and n-butanol, and also ethylene glycol, propylene glycol, butylene glycol, 1,4-butanediol, 1,6-hexanediol, 1,12-dodecanediol, glycerol, diethylene glycol, dipropylene glycol, polyethylene glycols having an average of up to 200 ethylene oxide units per molecule (number average), preferably from 3 up to 20, polypropylene glycols having an average of up to 200 propylene oxide units per molecule (number average), preferably from 3 up to 20, polytetrahydrofuran having an average of up to 200 1,4-butanediol units per molecule (number average), preferably from 3 up to 20, and also singly C₁-C₁₀-alkyl-capped mono-, di-, or polyethylene or -propylene glycols having an average of up to 200 alkylene oxide units per molecule (number average), preferably from 3 up to 20.

Examples of further reactions after condensation are esterification reactions, etherification reactions, and free-radical (co)polymerization reactions.

In one embodiment of the present invention, compound (b) can be prepared from at least one nitrogen-containing compound (B1), from at least two carbonyl compounds (B2), and, for example, from up to 3 different further compounds (B3).

Particularly preferred examples of compounds (b) are those of the general formula I a to I b

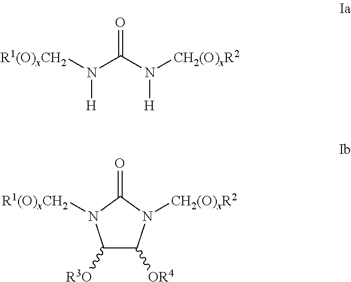

where the variables are defined as follows:
R¹ and R² are different or preferably identical, and are selected from hydrogen, C₁-C₁₂-alkyl, branched or unbranched, selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, and n-dodecyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl, and tert-butyl,
   —(—CH₂—CH₂—O)ₘ—R⁵, (—CHCH₃—CH₂—O)ₘ—R⁵, (—CH₂—CHCH₃—O)ₘ—R⁵, (—CH₂—CH₂—CH₂—O)ₘ—R⁵, (—CH₂—CH₂—CH₂—CH₂—O)ₘ—R⁵,
x is identical or different and is a whole number selected from zero and one, at least one x in formula I a being selected to be equal to one; in formula I b, both x can be selected to be equal to zero,
m is a whole number in the range from 1 to 20,
R³ and R⁴ are different or preferably identical, and are selected from hydrogen, C₁-C₁₂-alkyl, branched or unbranched, selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, and n-dodecyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl, and tert-butyl, and
R⁵ is identical or different, and is selected from C₁-C₄-alkyl, such as methyl, ethyl, n-propyl, isopropyl, n-butyl, isobutyl, sec-butyl, and tert-butyl
   and in particular hydrogen.

Compounds (b), in particular of the general formula I a and I b, are known per se. Compounds (b) in particular of the general formula I a and I b are not generally pure according to a defined formula; intermolecular rearrangements of the radicals R¹ to R⁴, i.e. transacetalization reactions and transaminalization reactions, are usually observed, as also to a certain extent are condensation reactions and cleavage reactions. The formula I a and, respectively, I b given above is intended to define the stoichiometric ratios of the substituents and also to comprise intermolecular rearrangement products and condensation products.

Another group of compounds (b) whose use is preferred is that of homo- and in particular copolymers of compounds of the general formula II

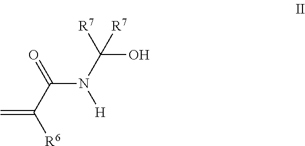

where the definitions of the variables are as follows:
R⁶ is selected from hydrogen and C₁-C₁₂-alkyl, preferably linear C₁-C₁₂-alkyl, selected from methyl, ethyl, n-propyl, n-butyl, n-pentyl, n-hexyl, n-heptyl, n-octyl, n-nonyl, n-decyl, and n-dodecyl; preferably linear C₁-C₆-alkyl, such as methyl, ethyl, n-propyl, n-butyl, n-pentyl, isopentyl, n-hexyl, particularly preferably C₁-C₄-alkyl, such as methyl, ethyl, n-propyl, and n-butyl, very particular preference being given here to hydrogen and methyl,
R⁷ is different or preferably identical, and selected from C₁-C₁₂-alkyl, preferably linear C₁-C₁₂-alkyl, selected from methyl, ethyl, n-propyl, n-butyl, n-pentyl, n-hexyl, n-heptyl, n-octyl, n-nonyl, n-decyl, and n-dodecyl; preferably linear C₁-C₆-alkyl, such as methyl, ethyl, n-propyl, n-butyl, n-pentyl, isopentyl, n-hexyl, particularly preferably C₁-C₄-alkyl, such as methyl, ethyl, n-propyl, and n-butyl,
   and particularly preferably hydrogen.

In formula II it is particularly preferable that both variables R⁷ are hydrogen and that R⁶ is selected from methyl or hydrogen.

Molar masses M_{w} of homo- and copolymers whose use is preferred, composed of compounds of the general formula II, can by way of example be in the range from 500 to 100 000 g/mol, preferably from 1000 to 50 000 g/mol.

If the intention is to use copolymers of one or more compounds of the general formula II, it is in particular possible to use copolymers of one or more compounds of the general formula II with one or preferably at least two comonomers, selected from one or more C₁-C₁₀-alkyl (meth)acrylates, in particular using methyl acrylate, ethyl acrylate, n-butyl (meth)acrylate, 2-ethylhexyl (meth)acylate, (meth)acrylic acid, vinylaromatic compounds, such as styrene, (meth)acrylonitrile, and
(meth)acrylamide.

If the intention is to use copolymers containing at least one copolymerized comonomer which contains OH groups or which contains β-dicarbonyl groups, or which contains epoxy groups, it is preferable to use copolymers containing at least one copolymerized comonomer of the general formula III

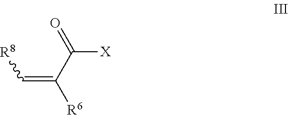

where the definitions of the variables are as follows:
R⁸ is selected from C₁-C₁₂-alkyl, preferably linear C₁-C₁₂-alkyl, selected from methyl, ethyl, n-propyl, n-butyl, n-pentyl, n-hexyl, n-heptyl, n-octyl, n-nonyl, n-decyl, and n-dodecyl; preferably linear C₁-C₆-alkyl, such as methyl, ethyl, n-propyl, n-butyl, n-pentyl, isopentyl, n-hexyl, particularly preferably C₁-C₄-alkyl, such as methyl, ethyl, n-propyl, and n-butyl,
   and very particularly preferably hydrogen,
X is selected from OH, glycidyl, 2-hydroxyethyl, 3-hydroxypropyl,

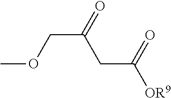

where
R⁹ is selected from C₁-C₁₂-alkyl, branched or unbranched, selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, and n-dodecyl; preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl, and tert-butyl, very particularly preferably methyl.

If the intention is to use, as (b), copolymers which comprise a comonomer of the general formula III, where X=OH, preference is given to copolymers which comprise no copolymerized ethylene as comonomer.

In one embodiment of the present invention, an aqueous formulation used in step (b) comprises an amount in the range from 1 to 60% by weight, preferably from 10 to 40% by weight, of compound (b).

Various techniques are conceivable for bringing compound (b) into contact with unmodified foams (a).

The contact can by way of example be brought about by immersion of unmodified foam (a) in an aqueous formulation of compound (b), by impregnation of unmodified foam (a) with an aqueous formulation of compound (b), by saturation of unmodified foam (a) with an aqueous formulation of compound (b), by spray-application of an aqueous formulation of compound (b) to some, or preferably all, of unmodified foam (a), or by calendering of an aqueous formulation of compound (b) onto unmodified foam (a).

In another embodiment of the present invention, the procedure for achieving contact applies an aqueous formulation of compound (b) by doctoring onto unmodified foam (a). After saturation and spray application, the material can be squeezed between at least two rolls, for example rotating rolls, in order to achieve uniform distribution of the formulation and set the desired concentration.

In one embodiment of the present invention, after contact has been achieved, unmodified foam (a) and the aqueous formulation of compound (b) can be allowed to interact with one another, for example over a period in the range from 0.1 seconds to 24 hours, preferably from 0.5 seconds to 10 hours, and particularly preferably from 1 second to 6 hours.

In one embodiment of the present invention, unmodified foam (a) and an aqueous formulation of compound (b) are brought into contact at temperatures in the range from 0° C. to 250° C., preferably from 5° C. to 190° C., and particularly preferably from 10 to 165° C.

In one embodiment of the present invention, unmodified foam (a) and an aqueous formulation of compound (b) are first brought into contact at temperatures in the range from 0° C. to 50° C., and the temperature is then changed, for example by heating to temperatures in the range from 60° C. to 250° C., preferably from 65° C. to 180° C.

In another embodiment of the present invention, unmodified foam (a) and an aqueous formulation of compound (b) are first brought into contact at temperatures in the range from 0° C. to 120° C., and then the temperature is changed, for example by heating to temperatures in the range from 30° C. to 250° C., preferably from 125° C. to 200° C.

In a preferred embodiment of the present invention, the amounts of the starting materials, unmodified foam (a) and an aqueous formulation of compound (b) are selected in such a way that the density of the product of the invention is markedly higher than that of the corresponding unmodified foam (a).

In one embodiment of the present invention, operations during the contact of unmodified foam (a) with an aqueous formulation of compound (b) are carried out at atmospheric pressure. In another embodiment of the present invention, operations for the conduct of the process of the invention are carried out at an elevated pressure, for example at pressures in the range from 1.1 bar to 10 bar. In another embodiment of the present invention, operations for the conduct of the process of the invention are carried out under a reduced pressure, for example at pressures in the range from 0.1 mbar to 900 mbar, preferably up to 100 mbar.

In one embodiment of the present invention, unmodified foam (a) is brought into contact with an aqueous formulation of compound (b) in such a way as to distribute compound (b) with maximum uniformity in all dimensions over unmodified foam (a). Suitable methods are methods using a high degree of application effectiveness. Examples that may be mentioned are: complete saturation, immersion, flow coating, drum application, spray application, e.g. compressed-air spraying, airless spraying, and also high-speed rotary atomization, coating, doctor application, calender application, spreading, roller application, wiping, rolling, spinning, and centrifuging.

In another embodiment of the present invention, unmodified foam (a) is brought into contact with an aqueous formulation of compound (b) in such a way as to bring about non-uniform distribution of the aqueous formulation of compound (b) onto unmodified foam (a). In one embodiment of the present invention, for example, an aqueous formulation of compound (b) can be applied to unmodified foam (a) non-uniformly by spraying, and the materials can then be allowed to interact. In another embodiment of the present invention, unmodified foam (a) can be incompletely saturated with an aqueous formulation of compound (b). In another embodiment of the present invention, a portion of unmodified foam (a) can be brought into contact once with an aqueous formulation of compound (b), and another portion of unmodified foam (a) can be brought into contact at least twice therewith. In another embodiment, unmodified foam (a) is completely saturated with an aqueous formulation of compound (b), and the uppermost layer is in turn rinsed with, for example, water. The materials are then allowed to interact. The result is to coat the core of unmodified foam (a); the exterior surface remains uncoated.

If unmodified foam (a) is brought into contact with an aqueous formulation of compound (b) in such a way that the resultant distribution of the aqueous formulation of compound (b) on unmodified foam (a) has been non-uniform, the result of, for example, allowing the materials to interact over a period of 2 minutes or more is that it is not only the outermost layer of unmodified foam (a) that is brought into contact with the aqueous formulation of compound (b).

If unmodified foam (a) is brought into contact with an aqueous formulation of compound (b) in such a way that the resultant distribution of the aqueous formulation of compound (b) on unmodified foam (a) has been non-uniform, it is possible according to the invention that the modified foam has non-uniform mechanical properties across its cross section. By way of example, it is therefore possible that according to the invention it is softer at locations where it has been brought into contact with relatively large proportions of the aqueous formulation of compound (b) than at locations where it has been brought into contact with a smaller amount of the aqueous formulation of compound (b).

In one embodiment of the present invention, calendering on perforated rolls or on perforated metal sheets can be used to achieve non-uniform distribution of the aqueous formulation of compound (b). Distribution of the aqueous formulation of compound (b) can be rendered more non-uniform by using vacuum for suction removal on at least one perforated roll or on at least one perforated metal sheet.

In one specific embodiment of the present invention, after the materials have been brought into contact, a defined liquor absorption is set through removal by squeezing between two counter-rotating rolls, for example in the range from 20 to 800% by weight, based on the weight of the unmodified foam (a). The concentration of compound (b) in the formulation is from 1 to 99% by weight.

In one embodiment of the present invention, after the materials have been brought into contact, rinsing may be carried out, for example with one or more solvents, and preferably with water.

In one embodiment of the present invention, after the materials have been brought into contact, and, if appropriate, after rinsing, drying may be carried out, for example mechanically, e.g. by wringing or calendering, and in particular through removal by squeezing through two rollers, or thermally, for example in microwave ovens, or hot-air blowers, or in drying ovens, in particular vacuum drying ovens, and drying ovens here can by way of example be operated at temperatures in the range from 30 to 150° C. In the context of vacuum drying ovens, vacuum means a pressure for example in the range from 0.1 to 850 mbar.

The time used for any desired drying steps carried out is excluded by definition from the interaction time for the purposes of the present invention.

In one embodiment of the present invention, thermal drying can be brought about by heating to temperatures in the range from 20° C. to 150° C., for example for a period of from 10 seconds to 20 hours.

In addition to an aqueous formulation of compound (b), it is possible according to the invention to bring unmodified foam (a) into contact with at least one catalyst (d). Examples of those suitable are metal salts and ammonium salts and inorganic or organic acids. Examples of suitable metal salts are metal halides, metal sulfates, metal nitrates, metal tetrafluoroborates, metal phosphates, or a mixture of these. Examples are magnesium chloride, magnesium sulfate, zinc chloride, lithium chloride, lithium bromide, boron trifluoride, aluminum chloride, aluminum sulfate, alums, such as KAI(SO₄)₂.12H₂O, zinc nitrate, sodium tetrafluoroborate, and mixtures of the metal salts described above.

Ammonium salts suitable as catalyst (d) are ammonium salts from the group of ammonium chloride, ammonium nitrate, ammonium sulfate, ammonium oxalate, diammonium phosphate, or a mixture of the ammonium salts described above.

Inorganic and organic acids suitable as catalyst (d) are maleic acid, formic acid, citric acid, tartaric acid, oxalic acid, para-toluenesulfonic acid, hydrochloric acid, sulfuric acid, boric acid, and mixtures of these.

It is naturally also possible to use, as catalyst (d), mixtures of, for example, at least one metal salt and at least one ammonium salt, or at least one metal salt or ammonium salt and at least one organic or inorganic acid.

Brønsted acid catalysts are very particularly preferred as catalyst (d), examples being ZnCl₂, Zn(NO₃)₂, in each case also in the form of their hydrates, NH₄Cl, MgSO₄, Al₂(SO₄)₃, in each case also in the form of their hydrates, and very particularly preferably MgCl₂, in particular in the form of its hexahydrate.

The amount used of catalyst (d), based on compound (b), is preferably from one third to one twentieth of the weight of catalyst (d), in each case determined without any water of hydrate present.

Preference is given to use of magnesium chloride, zinc chloride, magnesium sulfate, or aluminum sulfate. Magnesium chloride is particularly preferred.

In one embodiment of the present invention, unmodified foam (a) is brought into contact with an aqueous solution of compound (b) and, if appropriate, catalyst (d) at a pH in the range from 3.0 to 7.5, where the desired pH value can, if appropriate, be set by addition of acid, or aqueous alkali metal hydroxide, or of a buffer. It is preferable to use a buffer.

In one embodiment of the present invention, at least one unmodified foam (a) can be brought into contact not only with an aqueous formulation of compound (b) and, if appropriate, catalyst (d), but also with at least one additive (e), selected from biocides, such as silver particles or monomeric or polymeric organic biocides, e.g. phenoxyethanol, phenoxypropanol, glyoxal, thiadiazines, 2,4-dichlorobenzyl alcohols, and preferably isothiazolone derivatives, such as MIT (2-methyl-3(2H)-isothiazolone), CMIT (5-chloro-2-methyl-3(2H)-isothiazolone), CIT (5-chloro-3(2H)-isothiazolone), BIT (1,2-benzoisothiazol-3(2H)-one), and moreover copolymers of N,N-di-C₁-C₁₀-alkyl-ω-amino-C₂-C₄-alkyl (meth)acrylate, in particular copolymers of ethylene with N,N-dimethyl-2-aminoethyl (meth)acrylate, activated charcoal, colorants, such as dyes or pigments, fragrances, such as perfume, odor scavengers, such as cyclodextrins.

An example of a procedure for this brings at least one unmodified foam (a) into contact with an aqueous formulation of compound (b), and with at least one additive (e) in various operations or preferably simultaneously.

In one embodiment of the present invention, an aqueous formulation of compound (b) can receive additions of one or more additives (e), for example in proportions of from 0 to a total of 50% by weight, based on (b), preferably from 0.001 to 30% by weight, particularly preferably from 0.01 to 25% by weight, very particularly preferably from 0.1 to 20% by weight.

For the production of moldings used according to the invention, it is moreover possible to carry out one or more mechanical compressions after the aqueous formulation of compound (b) and, if appropriate, catalyst (d) and, if appropriate, at least one additive (e) has/have been allowed to interact with unmodified foam (a). The mechanical compression can be carried out batchwise or preferably continuously, for example batchwise by presses or platens, or for example continuously by rolls or calenders. If calendering is desired, one or more calender passes can be carried out, for example from one to twenty calender passes, preferably from five to ten calender passes.

In one embodiment of the present invention, mechanical compression is carried out until the degree of compaction is in the range from 1:1.2 to 1:12, preferably from 1:2.5 to 1:5.

In one embodiment of the present invention, the material is calendered prior to drying.

The procedure in one embodiment of the present invention is that, after an aqueous formulation of compound (b) and, if appropriate, catalyst (d) and, if appropriate, at least one additive (e) has/have been brought into contact with the material and the materials have been allowed to interact, the product is then dried, and then moistened with water, and then mechanically compressed, for example calendered.

The procedure in one embodiment of the present invention is that, after an aqueous formulation of compound (b) and, if appropriate, catalyst (d) and, if appropriate, at least one additive (e) has/have been brought into contact with, and allowed to interact with, unmodified foam (a), the materials can be heat-set, and specifically prior to or after the mechanical compression, or else between two mechanical-compression steps. By way of example, heat-setting can be carried out at temperatures of from 120° C. to 250° C. for a period of from 5 seconds up to 5 minutes. Examples of suitable apparatuses are microwave ovens, platen presses, with use of hot-air blowers, drying ovens heated electrically or by gas flames, heated roll mills, or continuously operated drying equipment.

Prior to the heat-setting, drying may be carried out, as described above.

The procedure in one embodiment of the present invention is that, after an aqueous formulation of compound (b) and, if appropriate, catalyst (d) and, if appropriate, at least one additive (e) has/have been brought into contact with, and allowed to interact with, unmodified foam (a), the materials can be heat-set, and specifically after or preferably prior to the mechanical compression, or else between two mechanical-compression steps. By way of example, heat-setting can be carried out at temperatures of from 150° C. to 200° C. for a period of from 30 seconds up to 5 minutes. Examples of suitable apparatuses are drying ovens.

In one specific embodiment, the mechanical compression and the heat-setting are combined, for example in that, after the materials have been allowed to interact and, if appropriate, the drying process, the foam is passed one or more times over hot rolls or calenders or is pressed one or more times between hot platens. It is also possible, of course, to calender the material repeatedly and in this process to compress it one or more times using cold rolls and one or more times using hot rolls. In the context of the present invention, hot means temperatures in the range from 100 to 250° C., preferably from 120 to 200° C.

At least one shaping step (c) is moreover carried out. The contact with an aqueous formulation of at least one compound (b) and the shaping step (c) can be carried out here in any desired sequence. It is preferable here to begin with contact with an aqueous formulation of compound (b) and then to carry out the shaping step (c).

In one embodiment of the present invention, the shaping step (c) is carried out mechanically, for example by milling, shredding, or granulating, and preferably by lacerating correspondingly larger parts, or by stamping, or by cutting.

In another embodiment of the present invention, unmodified foam (a) is produced as molding with the dimensions defined in the introduction, and the foaming process can in particular be carried out in molds, thus giving moldings of unmodified foam (a), which are then brought into contact with an aqueous formulation of at least one compound (b).

The present invention further provides moldings which are also termed moldings of the invention below, obtainable by the process described above.

In one embodiment of the present invention, moldings of the invention consist in essence of open-cell foam, i.e. foams in which at least 50% of all of the cell walls are open, preferably from 60 to 100%, and particularly preferably from 65 to 99.8%, determined to DIN ISO 4590.

The density of moldings of the invention is in the range from 5 to 1000 kg/m³, preferably from 6 to 500 kg/m³, and particularly preferably in the range from 7 to 300 kg/m³. The density of the foam of the invention is firstly affected by the degree of covering with compound (b) and, if appropriate, catalyst (d) and, if appropriate, at least one additive (e), and secondly by the degree of compaction of the starting material. Density and hardness or flexibility can be set as desired via suitable choice of degree of covering and degree of compaction.

Moldings of the invention preferably comprise an amount in the range from 0.1 to 95% by weight, preferably from 5 to 30% by weight, particularly preferably from 10 to 25% by weight, based on the weight of the corresponding unmodified foam (a), of solid composed of (b).

In one embodiment of the present invention, open-cell foams (a) involve foams composed of synthetic organic foam, and preferably involve polyurethane foam or melamine foam.

In one embodiment of the present invention, in step (b), the material is brought into contact with at least one compound of the general formula I a or I b

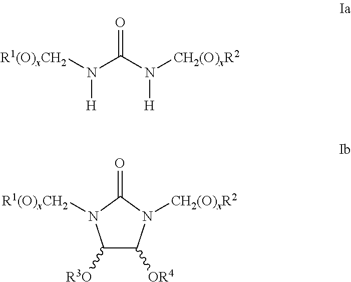

where the variables are defined as follows:
R¹ and R² are identical or different, and are selected from hydrogen, C₁-C₁₂-alkyl, branched or unbranched, (—CH₂—CH₂—O)ₘ—R⁵, (—CHCH₃—CH₂—O)ₘ—R⁵, (—CH₂—CHCH₃—O)ₘ—R⁵, (—CH₂—CH₂—CH₂—O)ₘ—R⁵, (—CH₂—CH₂—CH₂—CH₂—O)ₘ—R⁵,
x is identical or different and is a whole number selected from zero and one, at least one x in formula I a being selected to be equal to one,
m is a whole number in the range from 1 to 20,
R³ and R⁴ are identical or different, and are selected from hydrogen and C₁-C₁₂-alkyl, branched or unbranched, and
R⁵ is identical or different, and is selected from C₁-C₄-alkyl and hydrogen.

Moldings of the invention can by way of example be used as dust binders.

Moldings of the invention can in particular be used in vacuum cleaners, in particular in those known as bagless vacuum cleaners, for example as dust binders.

For the purposes of the present invention, dust binders are capable of binding coarse dust and preferably also the fine dust sucked into the vacuum cleaner, partially or preferably to a predominant extent, for example more than 50% by weight.

An example of a procedure for the use of moldings of the invention as dust binders can be as follows:

A vacuum cleaner is provided, in particular a bagless vacuum cleaner, having a dust collection container located within the air stream. The dust collection container can take the form of a cyclone, for example.

In one embodiment of the present invention, a plurality of moldings are directly fed into the dust collection container. The material is fed by using one or more feeders, which can have been integrated within the vacuum cleaner or within a suction attachment, or can take the form of external apparatus with a receiver for the dust collection container. There is therefore no need for any further active elements in the vacuum cleaner. The feeder or the feeders can by way of example take the form of a flap, piston, screw, or nozzle. Dust binders can be added directly or by way of a valve.

In another embodiment, moldings of the invention are fed directly into the dust collection container, and the dust collection container together with the moldings is placed into the vacuum cleaner.

In another embodiment of the present invention, moldings are fed automatically into the dust collection container. In this process, certain proportions of dust binder are fed continuously and further feed of appropriate amounts takes place continuously. This type of automatic further feed can also be carried out as a function of the amounts of dust.

Dust collection containers can have any desired shape and any desired size, as a function of the type of vacuum cleaner. For the purposes of the present invention, dust collection containers can therefore have cubic, cylindrical, conical, or irregular shape. Examples of suitable volumes are from 0.1 dm³ to 2 dm³, but larger volumes up to 10 dm³ are also conceivable.

The form taken by the dust collection container can by way of example be that of a bag or of a box, or similar to that of a cyclone (centrifugal separator). The fill level of the dust collection container can by way of example be monitored electronically or mechanically, for example by sensors.

In another embodiment, in particular for bagless vacuum cleaners, the form taken by the dust collection vessel can be that of a box or similar to that of a cyclone.

In one embodiment of the present invention, the dust collection container comprises an apparatus for mixing, for example a mechanical apparatus, such as a stirrer, or a motor which sets the dust collection vessel in motion, for example vibrations or rotations. In another embodiment of the present invention, the dust collection container comprises no apparatus for mixing.

In another specific embodiment of the present invention, moldings of the invention can be sheet-like, for example similar to a nonwoven layer, or mat, or piece of fabric, which serves as filter, for cleaning the air stream in the vacuum cleaner, before the air stream leaves the vacuum cleaner and is forced back into the environment. The thickness of sheet-like moldings of the invention can be in the range from 0.5 to 1.5 cm. The length and width of sheet-like moldings of the invention here are preferably markedly greater than the thickness, for example each being five times as great, preferably at least ten times as great. Length and width can be identical or different.

In one embodiment of the present invention, the thickness of sheet-like moldings of the invention is in the range from 0.5 to 1.5 cm, and their length and width are respectively in the range from 150 to 250 mm, preferably from 170 to 230 mm.

The surface of sheet-like moldings of the invention can have no further alterations, or else can have been pleated.

Sheet-like moldings of the invention can be fixed in vacuum cleaners of the invention by methods known per se, for example by using a filter frame, or in air-permeable or air-impermeable dust collection containers.

Sheet-like moldings of the invention can be used in vacuum cleaners of the invention, for example as deep-bed filter or flat filter, or—as a function of pore diameter—as prefilter or final filter.

In one embodiment of the present invention, the dust collection container is filled with moldings of the invention to an extent of from 10 to 60% by volume, preferably to an extent of from 25 to 50% by volume.

In one embodiment of the present invention, moldings of the invention can bind up to 3000% by weight of dust, based on their own weight, for example from 500 to 3000% by weight. Dust-binding capability can by way of example be determined gravimetrically.

The present invention further provides vacuum cleaners, in particular bagless vacuum cleaners, comprising at least one molding of the invention. The present invention further provides vacuum cleaners, in particular bagless vacuum cleaners, comprising at least one sheet-like molding of the invention.

Preference is given to bagless vacuum cleaners, comprising at least one molding of the invention, also termed bagless vacuum cleaners of the invention below. During operation of the bagless vacuum cleaner of the invention, (an) inventive molding(s) is/are kept in flotation together with the dust in the cyclone. In this application, the molding(s) of the invention operate(s) practically as dust binder (dust collector), in particular for fine dust, which can sometimes trigger allergies. Because dust and moldings of the invention are both kept in flotation, the dust particles adhere to moldings of the invention and thus lose their ability to move freely, and cannot therefore then raise a cloud of dust when the cyclone is emptied. Instead of this, they fall to the floor together with moldings of the invention. In this application, it is in essence the surface properties (adsorption) of the moldings of the invention that are used. Their advantageous filter properties are somewhat secondary in this instance.

It is also possible to use moldings of the invention in the fine-dust filter or as fine-dust filter, in order to prolong its operating time; the same applies to dust bags.

The present invention further provides a process for the production of moldings, also termed production process of the invention below, comprising
(a) provision of an open-cell foam whose density is in the range from 5 to 500 kg/m³, and whose average pore diameter is in the range from 1 μm to 1 mm,
(b) contact with an aqueous formulation of at least one compound having at least one hemiaminal or aminal group per molecule or at least one copolymer containing at least one copolymerized comonomer which contains OH groups or which contains β-dicarbonyl groups, or which contains epoxy groups, and
(c) carrying out a shaping step, by which the relevant moldings obtain length width height dimensions that are always in the range from 1 mm to 3 cm, at least one dimension being greater than 5.5 mm,
   where the contact with an aqueous formulation of at least one compound (b) and the shaping step (c) can be carried out in any desired sequence.

The present invention further provides a process for the production of sheet-like moldings whose thickness is in the range from 0.5 to 1.5 cm, likewise subsumed under the term “production process of the invention” below, comprising
(a) provision of an open-cell foam whose density is in the range from 5 to 500 kg/m³, and whose average pore diameter is in the range from 1 μm to 1 mm,
(b) contact with an aqueous formulation of at least one compound having at least one hemiaminal or aminal group per molecule or at least one copolymer containing at least one copolymerized comonomer which contains OH groups or which contains β-dicarbonyl groups, or which contains epoxy groups, and
(c) carrying out a shaping step,
   where the contact with an aqueous formulation of at least one compound (b) and the shaping step (c) can be carried out in any desired sequence.

Details of the production process of the invention have been listed above.

The present invention further provides a process for the cleaning of surfaces, in particular floors, by using vacuum cleaners of the invention, also termed cleaning process of the invention below. The procedure known per se can be used for conduct of the cleaning process of the invention. By virtue of the use of one or more vacuum cleaners of the invention, very clean exhaust air is produced and only a small amount of fine dust is raised.

Working examples are used to illustrate the invention. Testing in each of the working examples used “ground slate” mineral test dust with grain diameter range<200 μm and with 50% value<30 μm. However, other dust can also be used, examples being house dust, garden dust, sand, flour (kitchen dust), pollen, and carbon black.

### EXAMPLES

### I.1 Production of Unmodified Foam (a)

A spray-dried melamine/formaldehyde precondensate (molar ratio 1:3, molar mass about 500 g/mol) was added, in an open container, to an aqueous solution using 3% by weight of formic acid and 1.5% of the sodium salt of a mixture of alkyl sulfonates having from 12 to 18 carbon atoms in the alkyl radical (K 30 emulsifier from Bayer AG), where the percentages are based on the melamine/formaldehyde precondensate. The concentration of the melamine/formaldehyde precondensate, based on the entire mixture composed of melamine/formaldehyde precondensate and water, was 74% by weight. The mixture thus obtainable was vigorously stirred, and 20% by weight of n-pentane were then added. Stirring was continued for sufficient time (about 3 min) to produce a dispersion of homogeneous appearance. This was applied by doctoring to a Teflon-treated glass textile as backing, and foamed and cured in a drying oven in which the prevailing air temperature was 150° C. The temperature established here in the bulk of the foam was the boiling point of n-pentane, which under these conditions is 37.0° C. After from 7 to 8 min, the maximum rise height of the foam had been achieved. The foam was left for a further 10 min at 150° C. in the drying oven; it was then heat-conditioned at 180° C. for 30 min. This gave unmodified foam (a.1).

The following properties were determined on the unmodified foam (a.1) from example I.1:

99.6% open-cell to DIN ISO 4590,
compression hardness (40%) 1.3 kPa, determined to DIN 53577,
density 7.6 kg/m³, determined to EN ISO 845,
average pore diameter 210 μm, determined by evaluating micrographs of sections,
BET surface area 6.4 m²/g, determined to DIN 66131,
sound absorption 93%, determined to DIN 52215,
sound absorption more than 0.9, determined to DIN 52212.

### I.2 Production of Modified Foams

### I.2.1 Production of a Modified Foam

Unmodified foam (a.1) from example 1.1 was cut to give foam blocks with dimensions 9 cm·4 cm·4 cm. The weight of the foam blocks was in the range from 1.00 to 1.33 g. A plurality of unmodified foam pieces with weight according to table 1 were then brought into contact with an aqueous dispersion comprising 81 g/l of N,N′-dimethyl-4,5-dihydroxyimidazolinone (I b.1) and 18 g/l of MgCl₂.6H₂O,

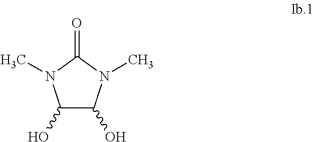

by in each case completely immersing a foam block in the aqueous dispersion and leaving it for two minutes under the aqueous dispersion. The foam blocks were then removed from the corresponding aqueous dispersion and excess aqueous dispersion was removed by squeezing, by passing the material between two counter-rotating rolls whose diameter was 150 mm and whose separation was 8 mm, and whose speed of rotation was 32 rotations/min. Liquor absorption of 520% by weight was thus achieved.

The material was then dried in a drying oven at 80° C. for a period of 4 hours. Heat-setting was then carried out in the drying oven at 150° C. for 10 minutes. The product was modified foam S1.1.

### I.2.2 Production of Modified Foam S1.2

The experiment according to I.2.1 was repeated, but the material was brought into contact with an aqueous dispersion of

### 120 g/l (I b.1), and

### 106.8 g91 MgCl₂.6H₂O.

The foam blocks were removed immediately after immersion, and material was removed by squeezing as described above, the liquor absorption achieved being 540% by weight.

Heat-setting was then carried out without prior drying, in a drying cabinet at 150° C. for 15 minutes.

The product was modified foam S1.2.

### I.2.3 Production of Modified Foam S2.1

Blocks (dimensions: 9 cm·4 cm·4 cm) of unmodified foam (a.1) were sprayed with 3.9 times the amount of an aqueous dispersion comprising

### 112.5 g/l (I b.2), and

### 61.4 g/l MgCl₂.6H₂O.

The materials were allowed to interact for 2 minutes, and material was removed by squeezing as described under 1.2, and heat-setting was carried out in a drying cabinet at 140° C. for 20 minutes. The liquor absorption achieved was 425% by weight.

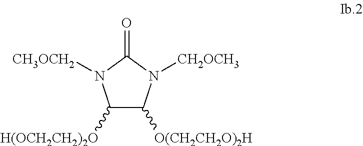

The product was modified foam S2.1.

### I.2.4 Production of Modified Foam S2.2

A plurality of unmodified foam pieces from example 1.1 with weight according to table 1 were then brought into contact with an aqueous dispersion comprising

### 112.5 g/l (I b.2), and

### 61.4 g/l MgCl₂.6H₂O,

by in each case completely immersing a foam block in the aqueous dispersion and leaving it for two minutes under the aqueous dispersion. The foam blocks were then removed from the corresponding aqueous dispersion and excess aqueous dispersion was removed by squeezing, by passing the material between two counter-rotating rolls whose diameter was 150 mm and whose separation was 8 mm, and whose speed of rotation was 32 rotations/min. Liquor absorption of 110% by weight was thus achieved.

The material was then dried in a drying oven at 80° C. for a period of 1 hour. Heat-setting was then carried out in the drying oven at 160° C. for 10 minutes. The product was modified foam S2.2.

### I.2.5 Production of Modified Foam S2.3

A plurality of unmodified foam pieces from example I.1 with weight according to table 1 were then brought into contact with an aqueous dispersion comprising

### 60 g/l (I b.2), and

### 25 g/l MgCl₂.6H₂O,

by in each case completely immersing a foam block in the aqueous dispersion and leaving it for two minutes under the aqueous dispersion. The foam blocks were then removed from the corresponding aqueous dispersion and excess aqueous dispersion was removed by squeezing, by passing the material between two counter-rotating rolls whose diameter was 150 mm and whose separation was 6 mm, and whose speed of rotation was 32 rotations/min. Liquor absorption of 273% by weight was thus achieved.

Heat-setting was then carried out (without prior drying) at 150° C. for 10 minutes in a drying oven. The product was modified foam S2.3.

### I.2.6 Production of Modified Foam S2.4

The procedure was as described in example 11.4, but the material was dried, prior to the heat-setting, for 2 hours at 80° C. in a drying oven, and heat-setting was carried out at 180° C. for 5 minutes. The product was modified foam S2.4.

TABLE 1
Modified foams (data in % by weight, based
on the weight of the unmodified foam)

| | | Weight of | Weight of | |
|---|---|---|---|---|
| | Modified | unmodified foam | modified | |
| (b) | foam No. | block [g] | foam [g] | Δ [% by wt.] |
| (b I.1) | S1.1 | 1.09 | 1.57 | 44 |
| (b I.1) | S1.2 | 1.21 | 2.0 | 65 |
| (b I.2) | S2.1 | 1.13 | 1.67 | 48 |
| (b I.2) | S2.2 | 1.22 | 1.37 | 12 |
| (b I.2) | S2.3 | 1.15 | 1.32 | 15 |
| (b I.2) | S2.4 | 1.11 | 1.41 | 27 |

### II. Production of Moldings of the Invention

A hammer and wad punch were used on a piece of S2.3 foam in the form of a mat of thickness 3 cm, to punch moldings of the invention: cylinders of diameter 5 mm and height 1 cm (F.1) and cylinders of diameter 10 mm and height 3 cm (F.2).

### III. Use as Dust Binder

A molding of the invention according to II. and 40 g of mineral test dust “ground slate” were charged to a cyclone (external dimensions: height=260 mm, diameter=150 mm), and fluidized using an air stream of velocity 20 m/s over a period of one minute. The mineral test dust particles collided with the molding of the invention here and were adsorbed. The increase in weight of the mineral-test-dust-loaded moldings of the invention was then determined gravimetrically. The weight of the molding of the invention was found to have increased by a factor of about 15. Light-scattering methods led to further conclusions in relation to the particle diameters of adsorbed mineral test dust (see table 2) and chemical constitution (inorganic or organic). Moldings of the invention exhibited excellent dust-binding capability, for example when compared with moldings composed of unmodified foam (a.1) of the same shape.

TABLE 2
Particle diameter distribution of adsorbed mineral test
dust, rel. increase in weight of specimen: 15-fold.

| Grain size boundaries [μm] | Percent by weight |
|---|---|
| 0.5-1 | 50.05 |
| 1-2 | 33.82 |
| 2-3 | 6.49 |
| 3-4 | 4.14 |
| 4-5 | 2.41 |
| 5-6 | 1.08 |
| 6-150 | 2.01 |

1. A method of manufacturing a vacuum cleaner containing a dust binder, comprising:
positioning a molding whose length·width·height dimensions are always in the range from 1 mm to 3 cm, at least one dimension being greater than 5.5 mm, which is produced by treatment of
(a) an open-cell foam whose density is in the range from 5 to 500 kg/m³ and whose average pore diameter is in the range from 1 μm to 1 mm
(b) with an aqueous formulation of at least one compound having at least one hemiaminal or aminal group per molecule or at least one copolymer containing at least one copolymerized comonomer which contains OH groups or which contains β-dicarbonyl groups, or which contains epoxy groups, and
(c) a shaping step, wherein the shaping is in the form of a dust binder for said vacuum cleaner.

2. A method of manufacturing a vacuum cleaner containing a dust binder, comprising:
positioning a molding whose thickness is in the range from 0.5 to 1.5 cm, produced by treatment of
(a) an open-cell foam whose density is in the range from 5 to 500 kg/m³ and whose average pore diameter is in the range from 1 μm to 1 mm
(b) with an aqueous formulation of at least one compound having at least one hemiaminal or aminal group per molecule or at least one copolymer containing at least one copolymerized comonomer which contains OH groups or which contains β-dicarbonyl groups, or which contains epoxy groups, and
(c) a shaping step, wherein the shaping is in the form of a dust binder for said vacuum cleaner.

3. The method according to claim 1, wherein at least one compound from step (b) has not been used during the production of open-cell foam (a).

4. The method according to claim 1, wherein open-cell foams (a) are foams comprised of synthetic organic foam.

5. The method according to claim 1, wherein open-cell foams (a) are polyurethane foams or aminoplastic foams.

6. The method according to claim 1, wherein, in step (b), there is contact with at least one compound of formula I a or I b 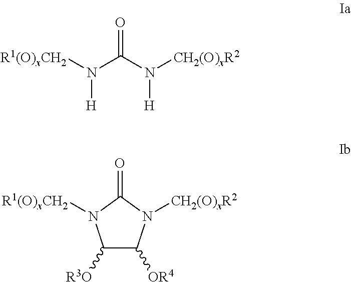
where the variables are defined as follows:
R¹ and R² are identical or different, and are selected from the group consisting of hydrogen, C₁-C₁₂-alkyl, branched or unbranched, (—CH₂—CH₂—O)ₘ—R⁵, (—CHCH₃—CH₂—O)ₘ—R⁵, (—CH₂—CHCH₃—O)ₘ—R⁵, (—CH₂—CH₂—CH₂—O)ₘ—R⁵, and (—CH₂—CH₂—CH₂—CH₂—O)ₘ—R⁵,
x is identical or different and is zero or one, at least one x in formula I a being one,
m is a whole number in the range from 1 to 20,
R³ and R⁴ are identical or different, and are selected from the group consisting of hydrogen and C₁-C₁₂-alkyl, branched or unbranched, and
R⁵ is identical or different, and is selected from the group consisting of C₁-C₄-alkyl and hydrogen.

7. The method according to claim 1, wherein the shaping step (c) is by lacerating, stamping, or cutting.

8. A molding whose length·width·height dimensions are always in the range from 1 mm to 3 cm, at least one dimension being greater than 5.5 mm, prepared by a process comprising:
(a) contacting an open-cell foam whose density is in the range from 5 to 500 kg/m³, and whose average pore diameter is in the range from 1 μm to 1 mm, with (b) an aqueous formulation of at least one compound having at least one hemiaminal or aminal group per molecule or at least one copolymer containing at least one copolymerized comonomer which contains OH groups or which contains β-dicarbonyl groups, or which contains epoxy groups, and
(c) shaping the contacted foam, wherein the contacting step and the shaping step are conducted in any desired sequence.

9. A flat molding whose thickness is in the range from 0.5 to 1.5 cm, prepared by a process comprising:
(a) contacting an open-cell foam whose density is in the range from 5 to 500 kg/m³ and whose average pore diameter is in the range from 1 μm to 1 mm with (b) an aqueous formulation of at least one compound having at least one hemiaminal or aminal group per molecule or at least one copolymer containing at least one copolymerized comonomer which contains OH groups or which contains β-dicarbonyl groups, or which contains epoxy groups, and
(c) shaping the contacted foam, wherein the contacting and shaping steps are conducted in any desired sequence.

10. The molding according to claim 8, wherein open-cell foams (a) are foams comprised of synthetic organic foam.

11. The molding according to claim 8, wherein open-cell foams (a) are polyurethane foams or aminoplastic foams.

12. The molding according to claim 8, wherein, in step (b), there is contact with at least one compound of formula I a or I b 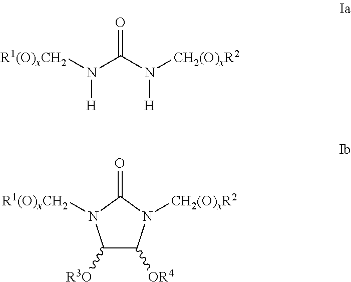
where the variables are defined as follows:
R¹ and R² are identical or different, and are selected from the group consisting of hydrogen, C₁-C₁₂-alkyl, branched or unbranched, (—CH₂—CH₂—O)ₘ—R⁵, (—CHCH₃—CH₂—O)ₘ—R⁵, (—CH₂—CHCH₃—O)ₘ—R⁵, (—CH₂—CH₂—CH₂—O)ₘ—R⁵, (—CH₂—CH₂—CH₂—CH₂—O)ₘ—R⁵,
x is identical or different and is zero or one, at least one x in formula I a is one,
m is a whole number in the range from 1 to 20,
R³ and R⁴ are identical or different, and are selected from hydrogen and C₁-C₁₂-alkyl, branched or unbranched, and
R⁵ is identical or different, and is selected from the group consisting of C₁-C₄-alkyl and hydrogen.

13. A dust binder, comprising:
a molding according to claim 8.

14. (canceled)

15. A vacuum cleaner, comprising at least one molding according to claim 8.

16. A process for the production of moldings, comprising
(a) contacting an open-cell foam whose density is in the range from 5 to 500 kg/m³, and whose average pore diameter is in the range from 1 μm to 1 mm, contact with (b) an aqueous formulation of at least one compound having at least one hemiaminal or aminal group per molecule or at least one copolymer containing at least one copolymerized comonomer which contains OH groups or which contains β-dicarbonyl groups, or which contains epoxy groups, and
(b) by which the moldings obtain length·width·height dimensions that are always in the range from 1 mm to 3 cm, at least one dimension being greater than 5.5 mm, wherein the contacting step and the shaping step can be carried out are conducted in any desired sequence.

17. A process for the production of sheet-like moldings whose thickness is in the range from 0.5 to 1.5 cm, comprising:
(a) contacting an open-cell foam whose density is in the range from 5 to 500 kg/m³, and whose average pore diameter is in the range from 1 μm to 1 mm, with (b) an aqueous formulation of at least one compound having at least one hemiaminal or aminal group per molecule or at least one copolymer containing at least one copolymerized comonomer which contains OH groups or which contains β-dicarbonyl groups, or which contains epoxy groups, and
(c) conducting shaping, wherein the contacting step and the shaping step are conducted in any desired sequence.

18. A method for the cleaning of surfaces with at least one vacuum cleaner according to claim 15.

19. The method according to claim 18, wherein said surfaces are floors.
